(19) United States
(12) Patent Application Publication
(10) Pub. No.: US 2014/0167512 A1
(43) Pub. Date: Jun. 19, 2014

(54) Method and Apparatus for Powering a Set of Direct-Current Consuming Loads

(71) Applicant: Raz Imports, Inc., Arlington, TX (US)

(72) Inventors: Kenneth Carl Row, Arlington, TX (US); Stone Lai, Guang Dong (CN)

(73) Assignee: RAZ IMPORTS, INC., Arlington, TX (US)

(21) Appl. No.: 14/106,747

(22) Filed: Dec. 14, 2013

Related U.S. Application Data
(60) Provisional application No. 61/738,268, filed on Dec. 17, 2012.
(60) Provisional application No. 61/737,673, filed on Dec. 14, 2012.

(51) Int. Cl. H02J 1/06

(52) U.S. Cl. CPC H02J 1/06
USPC 307/42

(57) ABSTRACT

Set of linked together, direct current powered decorative ornaments. A branched power supply cord is provided that powers a plurality of decorative ornaments, each ornament having a direct current consuming load. The supply cord can include an elongate trunk supply line terminating at a base-end in a pronged plug configured for plugged insertion into an alternating current outlet. The pronged plug can be electrically coupled upstream to a switched-mode power supply having an AC-to-DC rectifier and having variable power output capability, the magnitude of which can be determined by the instant load demand thereupon. An operator-actuable switch can be electrically coupled downstream of the switched-mode power supply and can be electrically coupled upstream of a branched distal portion of the trunk supply line that has a plurality of lead-lines.

### CROSS-REFERENCE TO RELATED APPLICATIONS

The present application claims priority and the benefit of U.S. Provisional Patent Application No. 61/737,673, filed Dec. 14, 2012, and U.S. Provisional Patent Application No. 61/738,268, filed Dec. 17, 2012, each of which is hereby incorporated by reference in its entirety.

### FIELD

The present disclosure relates to a method and apparatus for powering a set of decorative ornaments that include direct-current consuming loads, such as light bulbs, and which may have been originally configured to be powered by batteries.

### BRIEF DESCRIPTION OF THE DRAWINGS

FIG. 1 is a perspective view of a set of decorative ornaments lined out along the mantle of the fireplace.

FIG. 2 is a perspective view of at least two ornaments installed on an Christmas tree with a branched power supply cord configured according to the current illustrated disclosure.

FIG. 3 is a perspective view of a branched power supply cord configured according to the current disclosure.

FIG. 4 is a perspective view of an ornament set powered by a branched power supply cord configured according to the current disclosure.

FIG. 5 is a similar perspective view to that of FIG. 4, but extension lines are utilized for positioning the individual ornaments farther away from the trunk supply line.

FIG. 6 is a schematic, perspective view of a decorative ornament (e.g. snowman) originally configured to be battery powered, but which has been converted according to the current teachings to be supplied power from an electrical outlet.

While the present disclosure is susceptible to various modifications and alternative forms, specific embodiments thereof have been shown in the drawings and will be described in detail. It should be understood, however, that it is not intended to limit the present disclosure to the particular forms shown, but on the contrary, the intention is to cover all modifications, equivalents, and alternatives falling within the scope of the present disclosure as defined by the appended claims.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The term “coupled” is defined as connected, whether directly or indirectly through intervening components, and is not necessarily limited to physical connections. The connection can be such that the objects are permanently connected or releasably connected.

Many decorative ornaments, especially those popular during the holidays, are often configured to be powered by batteries, such battery powered decorative ornaments are less than optimal in at least two respects. By the nature of the use of batteries, they eventually go dead and must be replaced, typically at great expense. In another aspect, each ornament must be individually turned on and turned off, which is not only time-consuming but can be annoying. In some cases the ornament is on a Christmas tree in a hard to reach place and causes the operator to assume precarious positions in order to just turn the ornament on and off. The present disclosure presents an improved solution with respect to turning the ornaments on and off in unison, as well as negating the need for replacing batteries.

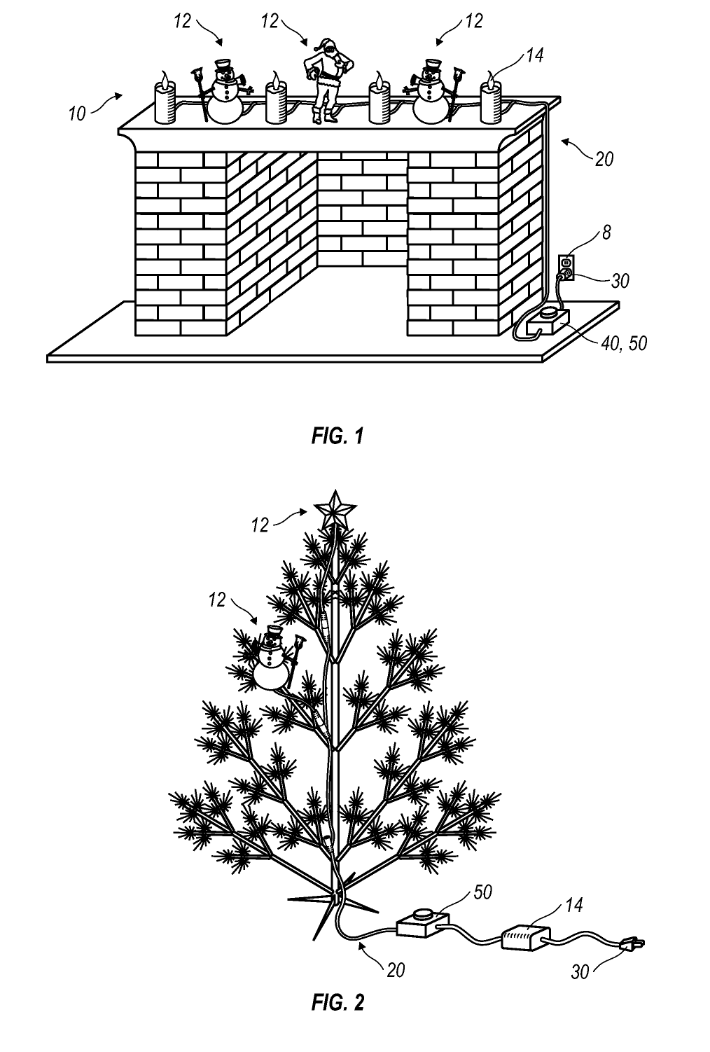

In at least one embodiment as illustrated in FIG. 1, the current disclosure depicts a branched power supply cord 20 for powering a plurality of direct current consuming loads 14. The direct current summing loads 14 as illustrated are lights on artificial candles. The direct current summing loads 14 can be other types of devices that require power. Additionally, the branched power supply cord 20 can supply power to direct-current (DC) powered decorative ornaments 12. FIG. 1 is a perspective view of a set of decorative ornaments 12 lined out along the mantle of the fireplace. FIG. 2 is a perspective view of at least one snowman ornament 12 and at least one star ornament 12 installed on an artificial Christmas tree with a branched power supply cord 20. The present disclosure can also be implemented with under counter lighting or in other environments where a plurality of devices are powered by a single power supply.

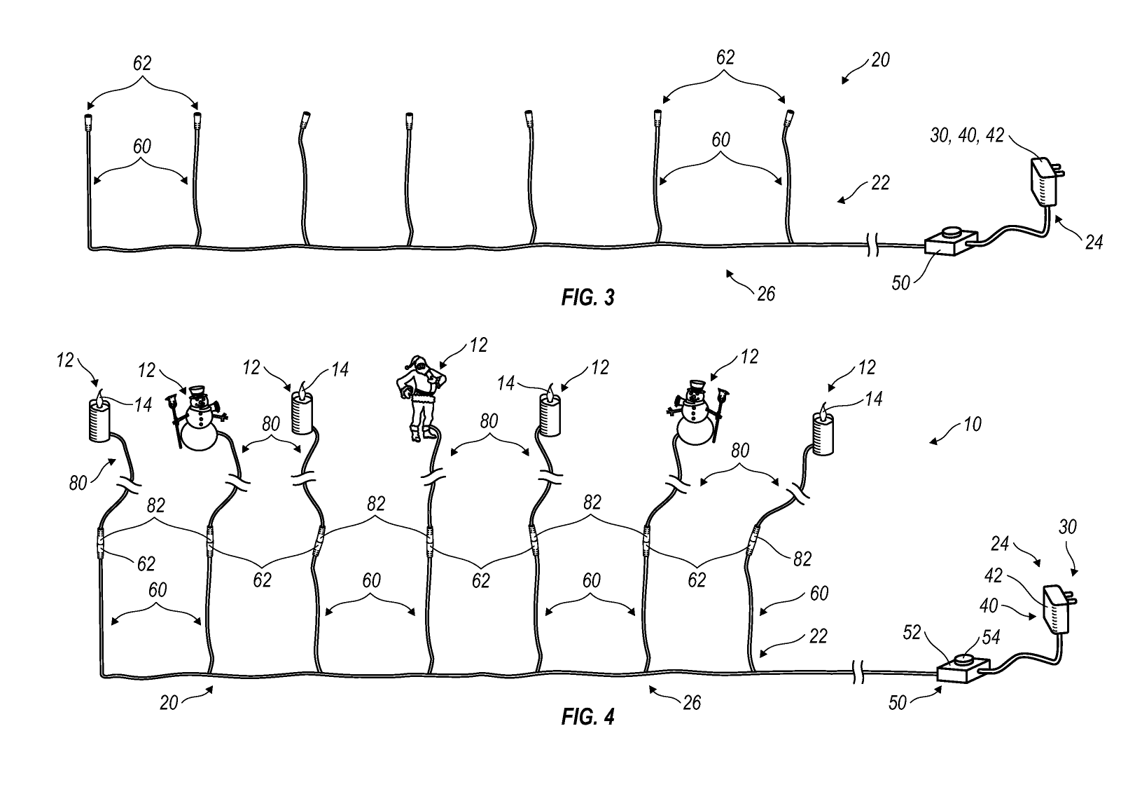

The supply cord 20 comprises (includes, but is not limited to) an elongate trunk supply line 22 terminating at a base-end 24 in a pronged plug 30 configured for plugged insertion into an alternating current outlet 8 such as that which is found in most residential and commercial buildings. The pronged plug 30 is electrically coupled upstream to a switched-mode power supply 40 comprising an AC-to-DC rectifier 42 and having variable power output capability, the magnitude of which is determined by the instant load demand thereupon. An operator-actuable switch 50 can be electrically coupled downstream of the switched-mode power supply 40 and can be electrically coupled upstream of a branched distal portion 26 of the trunk supply line 22 that comprises a plurality of lead-lines 60 (see FIGS. 3 and 4). Each of the lead-lines 60 can be electrically connected to the trunk supply line 22 at one of two ends of the lead-line 60 and terminates in a female plug 62 receiver at an opposite of the two ends of the lead-line 60. The operator-actuable switch 50 can have an open configuration in which electricity is prevented from flowing from the switched-mode power supply 40 to the plurality of lead-lines 60 and a closed configuration in which electricity can be permitted to flow from the switched-mode power supply 40 to the plurality of lead-lines 60. In other embodiments, the switched-mode power supply 40 can be configured to power a portion of the plurality of lead-lines 60. For example, the switched-mode power supply can be configured to power only a first half of the plurality of lead-lines 60, a second half of the plurality of lead-lines 60, every other one of the plurality of lead-lines 60 or another configuration. When these are provided the switch 50 can be configured to allow for a series of these configurations.

The operator-actuable switch 50 is a toggle switch in which successive actuation transitions the switch alternately between the open and closed configurations or another combination as indicated above.

In one example as illustrated in FIG. 4, the operator-actuable switch 50 is a push-button switch. In this configuration, the push-button switch 50 can include a base 52 configured to rest on a floor or other surface and a button 54 configured to be actuated by an operator, for example by the foot of the operator when the push-button switch 50 is on the floor. In other embodiments, the push-button switch 50 can be configured to be placed on a mantle or other surface. In yet other embodiments, the push-button switch 50 can be configured so that it can be suspended without having to rest on any other object.

Each of the lead-lines 60 can be electrically connected in parallel with the others of the plurality of lead-lines 60 along the branched distal portion 26 of the trunk supply line 22. In one example the plurality of lead-lines 60 can be of various lengths. In another example the plurality of lead-lines 60 each have substantially the same length.

Each of the female plug receivers 62 can be substantially cylindrical in exterior shape. An electrical contact can be provided in each of the female plug receivers 62 such that each electrical contact is shrouded within an electrically insular body of the incorporating female plug receiver 62. When the female plug receiver 62 is provided, the plurality of lead-lines 60 can be subject to less accidental discharge of power.

In at least one example as illustrated in FIGS. 3-6, the pronged plug 30 can be integrated with the switched-mode power supply 40 by a common housing.

As illustrated in FIG. 4, a set 10 of linked together, direct current powered decorative ornaments 12, can be also disclosed herein. Similarly, a branched power supply cord 20 can be provided that powers a plurality of decorative ornaments 12, each ornament having a direct current consuming load 14. The supply cord 20 comprises an elongate trunk supply line 22 terminating at a base-end 24 in a pronged plug 30 configured for plugged insertion into an alternating current outlet 8. The pronged plug 30 can be electrically coupled upstream to a switched-mode power supply 40 comprising an AC-to-DC rectifier 42 and having variable power output capability, the magnitude of which is determined by the instant load demand thereupon. An operator-actuable switch 50 can be electrically coupled downstream of the switched-mode power supply 40 and can be electrically coupled upstream of a branched distal portion 26 of the trunk supply line 22 that comprises a plurality of lead-lines 60, each electrically connected to the trunk supply line 22 at one of two ends of the lead-line 60 and terminating in a female plug 62 receiver at an opposite of the two ends of the lead-line 60. The operator-actuable switch 50 can have an open configuration in which electricity is prevented from flowing from the switched-mode power supply 40 to the plurality of lead-lines 60 and a closed configuration in which electricity can be permitted to flow from the switched-mode power supply 40 to the plurality of lead-lines 60.

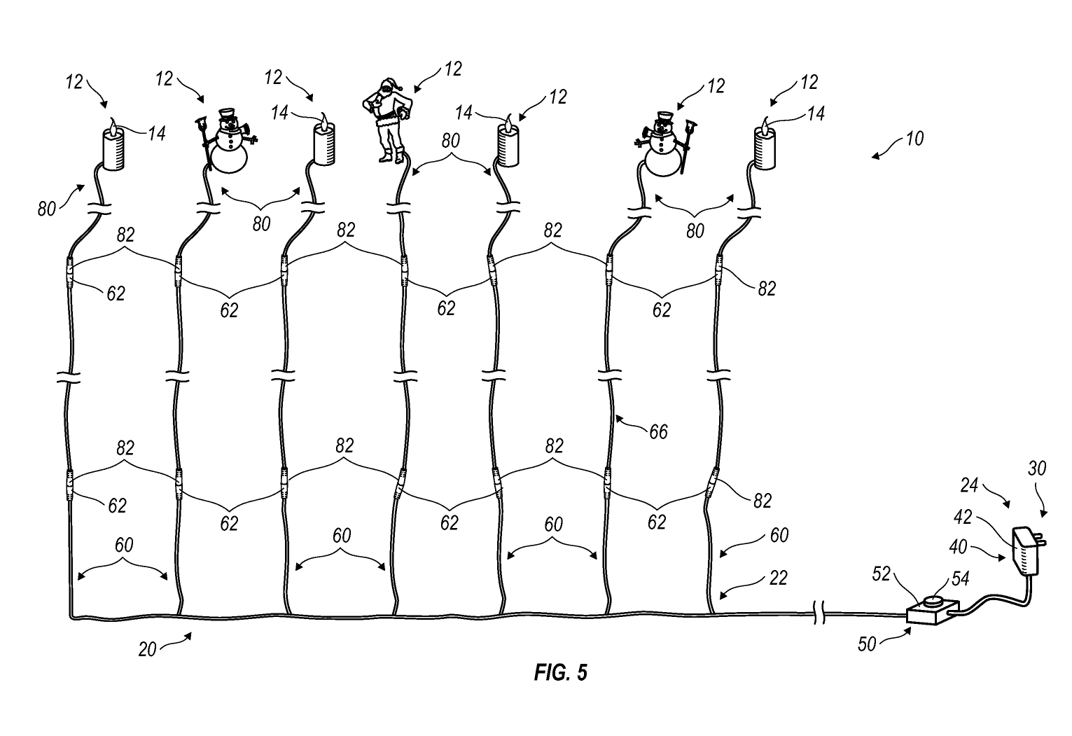

FIG. 5 is a similar perspective view to that of FIG. 4, but extension lines 66 can be utilized for positioning the individual ornaments 12 farther away from the trunk supply line 22. The extension lines 66 are configured to be coupled to the ornament connector male plug 82 at a first end and the female plug 62 of the lead-line 60. Thus, the extension lines 66 have a male plug 82 at one end and a female plug 62 at the other end. The extension lines 66 can be arranged to allow for extending the length of the transmission line 80 to the ornament 12 or can be arranged to provide a desired extension between the elongate trunk supply line 22 and the ornament 12.

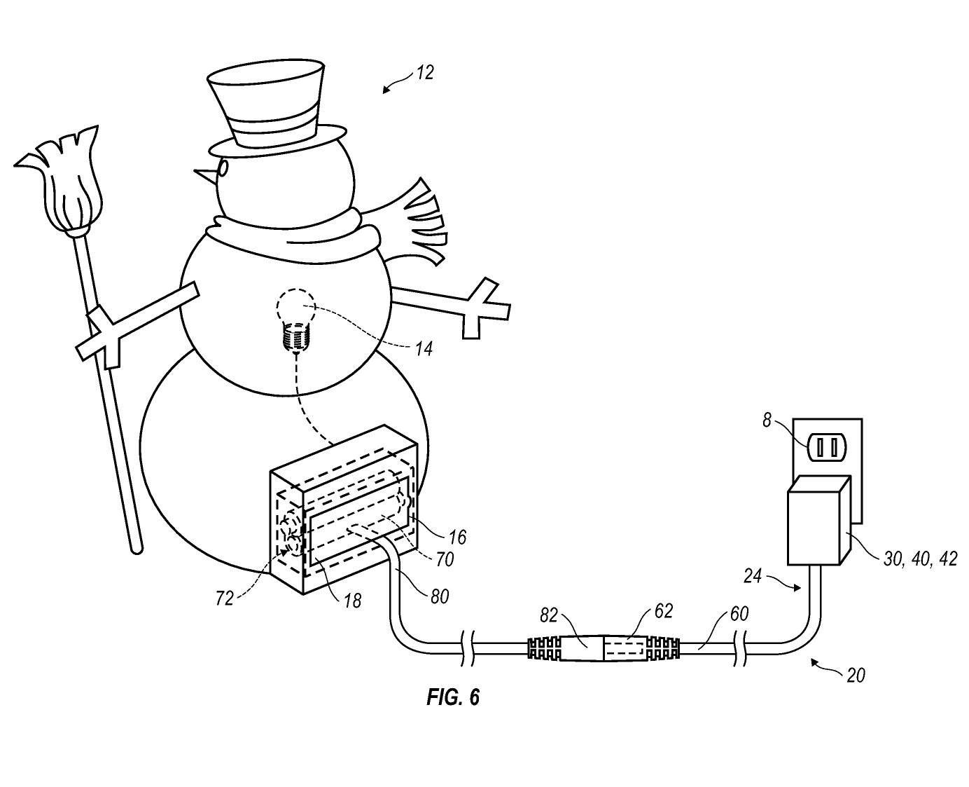

As may be appreciated in the snowman example of FIG. 6, each decorative ornament 12 can comprise a mock battery 70 having terminals 72 that supply power to the direct current consuming load 12 when the mock battery 70 is inserted into a battery holder 16 of the ornament 12. A transmission line 80 can extend from the mock battery 70 for supplying power from the branched power supply cord 20 to the terminals 72 of the mock battery 70.

In one example as illustrated in FIG. 6, a distal end of each transmission line opposite the respective mock battery 70 terminates in a male plug 82 inserted into a respective one of the female plug receivers 62 thereby establishing a friction fit and electrical connection therebetween. A battery cover 18 covers the compartment for the mock battery 70. U.S. Provisional Patent Application No. 61/737,673, filed Dec. 14, 2012 provides further details concerning one or more implementations of a mock battery 70 and is incorporated by reference in its entirety.

What is claimed is:

1. A branched power supply cord for powering a plurality of direct current consuming loads, the supply cord comprising:
an elongate trunk supply line terminating at a base-end in a pronged plug configured for plugged insertion into an alternating current outlet;
the pronged plug electrically coupled upstream to a switched-mode power supply comprising an AC-to-DC rectifier and having variable power output capability, the magnitude of which is determined by the instant load demand thereupon;
an operator-actuable switch electrically coupled downstream of the switched-mode power supply and electrically coupled upstream of a branched distal portion of the trunk supply line that comprises a plurality of lead-lines, each electrically connected to the trunk supply line at one of two ends of the lead-line and terminating in a female plug receiver at an opposite of the two ends of the lead-line; and
the operator-actuable switch having an open configuration in which electricity is prevented from flowing from the switched-mode power supply to the plurality of lead-lines and a closed configuration in which electricity is permitted to flow from the switched-mode power supply to the plurality of lead-lines.

2. The power supply cord as claimed in claim 1, wherein the operator-actuable switch is a toggle switch in which successive actuation transitions the switch alternately between the open and closed configurations.

3. The power supply cord as claimed in claim 2, wherein the operator-actuable switch is a push-button switch.

4. The power supply cord as claimed in claim 3, wherein the push-button switch has a base configured to rest on a floor and a button configured to be foot-actuated by an operator.

5. The power supply cord as claimed in claim 1, wherein each of the lead-lines is electrically connected in parallel with the others of the plurality of lead-lines along the branched distal portion of the trunk supply line.

6. The power supply cord as claimed in claim 5, wherein the plurality of lead-lines are of various lengths.

7. The power supply cord as claimed in claim 5, wherein the plurality of lead-lines each have substantially the same length.

8. The power supply cord as claimed in claim 1, wherein each of the female plug receivers is substantially cylindrical in exterior shape.

9. The power supply cord as claimed in claim 1, further comprising an electrical contact in each of the female plug receivers, wherein each electrical contact is shrouded within an electrically insular body of the incorporating female plug receiver.

10. The power supply cord as claimed in claim 1, wherein the pronged plug is integrated with the switched-mode power supply by a common housing.

11. A set of linked together, direct current powered decorative ornaments, the set comprising:
a branched power supply cord that powers a plurality of decorative ornaments, each ornament having a direct current consuming load;
the supply cord comprising an elongate trunk supply line terminating at a base-end in a pronged plug configured for plugged insertion into an alternating current outlet;
the pronged plug electrically coupled upstream to a switched-mode power supply comprising an AC-to-DC rectifier and having variable power output capability, the magnitude of which is determined by the instant load demand thereupon;
an operator-actuable switch electrically coupled downstream of the switched-mode power supply and electrically coupled upstream of a branched distal portion of the trunk supply line that comprises a plurality of lead-lines, each electrically connected to the trunk supply line at one of two ends of the lead-line and terminating in a female plug receiver at an opposite of the two ends of the lead-line;
the operator-actuable switch having an open configuration in which electricity is prevented from flowing from the switched-mode power supply to the plurality of lead-lines and a closed configuration in which electricity is permitted to flow from the switched-mode power supply to the plurality of lead-lines;
each decorative ornament comprising a mock battery having terminals that supply power to the direct current consuming load when the mock battery is inserted into a battery holder of the ornament; and
a transmission line extending from the mock battery for supplying power from the branched power supply cord to the terminals of the mock battery.

12. The set of linked together ornaments wherein a distal end of each transmission line opposite the respective mock battery terminates in a male plug inserted into a respective one of the female plug receivers thereby establishing a friction fit and electrical connection therebetween.
